(19) United States
(12) Patent Application Publication
(10) Pub. No.: US 2010/0000381 A1
(43) Pub. Date: Jan. 7, 2010

(54) Driver with tail

(76) Inventor: Atsushi Takahashi, Fukui (JP)

Correspondence Address: QUINTERO LAW OFFICE, PC, 2210 MAIN STREET, SUITE 200, SANTA MONICA, CA, 90405, US

(21) Appl. No.: 12/374,782

(22) PCT Filed: Jul. 27, 2007
(86) PCT No.: PCT/JP2007/064821

§ 371 Date: Jan. 22, 2009

(30) Foreign Application Priority Data
Jul. 31, 2006 (JP) 2006-208053

(51) Int. Cl. B25B 15/00; B25B 23/16; A61C 3/00

(52) U.S. Cl. 81/450; 81/177.6; 433/141

(57) ABSTRACT

[PROBLEMS] Entire body of a driver is composed of a material which can be sterilized by an autoclave or an ultrasonic cleaner; when the driver is used in a limited space such as in a body cavity, work can be carried out efficiently without causing any trouble with a rotary work, and aspiration aberrant entry can be prevented when the driver body is dropped by mistake; ; and amount of rotation, rotation angle or rotary torque can be recognized even at the molar tooth portion.

[MEANS FOR SOLVING PROBLEMS] A driver with a tail in which a metal or resin wire having proper resilient, flexible and shape restoring properties or a rope-like shaft composed of that wire is attached coaxially to a driver having a tip blade corresponding to various screw head fitting shapes of a driver handle on the side opposite to the installation side of the blade, and a rotary gauge or a digital torque sensor display is attached to the tip end of that shaft.

### FIELD OF THE INVENTION

The invention relates to a screw driver used in oral implanting operation or other operations for creatures in a narrow space.

### DESCRIPTION OF THE RELATED ART

A small tool made of antibiotic material similar to screw drivers used in industry is utilized in surgery operation to tighten or loosen screws. Particularly in a limited space, such as an oral cavity, a screw driver of very small length is required, which is, however, difficult to operate. It is possible for such a short screw driver to fall into the throat, which is dangerous for patients. To prevent such danger, a hole is formed on the main body of the screw driver, and a dental floss passes through the hole and knots but leaves 20 cm length outside the oral cavity. If the screw driver falls into the throat and is swallowed, the dental floss can serve as a stopper to pull the screw driver up. In addition, in oral cavity operation, it's hard to see the main body of the screw driver when the screw driver is operated in moral tooth which is hidden in the oral cavity. In such a small screw driver, a torque driver or a torque ratchet measuring the tightening torque utilizes mechanical mechanisms.

### DISCLOSURE OF THE INVENTION

### The Problem to be Solved

Since it is dangerous to swallow the screw driver, a dental floss is tightened to the screw driver. In case the screw driver falls, it can be pulled up with the dental floss. The dental floss, however, has no toughness; it can obstruct the rotation of the screw driver or wind around the lips or tongue when it is operated in the wet oral cavity or bleeding portions. For the antibiotic purpose, the dental floss is also not suitable. In addition, to operate the screw driver with precise torque, a torque sensor comprising strain gauge disposed on a sensor plate is preferred rather than the mechanical type one. However, it occupies considerable space in the narrow oral cavity for the type of the torque sensor integrated with a display device, and it's difficult to recognize the display device when used in a closed space. For the type of torque sensor separated from the display device, a wire connecting the torque sensor and the display device may obstruct the rotation of the screw driver like the dental floss.

The invention provides a screw driver made of an antibiotic material which can be disinfected in a high pressure disinfector or a supersonic cleaner. Such a screw driver can be used in a limited space such as the narrow oral cavity to rotate effectively therein. When the screw driver falls, swallow of the screw driver can be avoided. Even in the moral tooth portion, the rotation amount, rotation angle or torque can still be recognized.

### The Way to Solve the Problem

The screw driver with tail has a wire element, which is made of metal or resin with flexible and recoverable property, or a rope-shaped shaft formed by the wire element disposed on the side opposite to the tip blade corresponding to various engaging shapes of screw heads. A rotation gauge displaying the rotation torque is disposed on one end of the rope-shaped shaft. The signal of a tightening torque sensor disposed in a handle body is transferred by a signal line constituting the rope-shaped shaft or a part of the rope-shaped shaft. The structure is formed in such a manner that the rotation of the rope-shaped shaft and the handle body disposed on the other end of the rope-shaped shaft is not obstructed, and the rope-shaped shaft and the handle body can rotate co-axially. The screw driver has a display device to indicate tightening torque for any rotation position of the handle body and the rope-shaped shaft.

The screw driver has the following effects.

In a narrow oral cavity or a surgery portion, the screw driver is held by fingers to push the tip blade vertically, which corresponds to various engaging shapes of screw heads, to engage and rotate a screw to be operated. The operation takes much labor. Besides, the screw driver may fall due to the saliva or blood in the cavity. In the first invention, a wire element or a rope-shape shaft of metal or resin with slightly curved shape is disposed on the other end of the rotational shaft of the handle body. The wire element or a rope-shape shaft, which is flexible and soft, can deform when it interferes with teeth, gums or lips. When the interference disappears, the wire element or a rope-shape shaft recovers the slightly curved shape, whereby the other end of the tail (wire element or a rope-shape shaft) is maintained outside the oral cavity to prevent miss swallow.

The second invention discloses a rotation gauge disposed on the other end of the tail disclosed in the first invention, whereby the rotation gauge rotates simultaneously with the screw driver in the oral cavity.

The third invention discloses that a ball stud joining the wire element or the rope-shaped shaft in the first or second invention to the center of a ball engages with a slide bearing, which is disposed on the handle body and has a spherical contact surface, whereby the rope-shaped shaft can do swinging, inclined moving or rotation.

A rotation constrain means such as a rotation constrain pin mechanism is disposed in the ball or slide bearing of a ball joint mechanism. The rope-shaped shaft can swing, inclined move or rotate in a predetermined angle range limited by the ball joint mechanism and rotates along with the handle body simultaneously.

The fourth invention comprises a tail flexible shaft structure comprising a flexible tube rotatably disposed in such a manner that the rope-shaped shaft of the first, second or third invention passes through the flexible tube to become a core shaft, whereby the rotating rope-shaped shaft is avoided to touch teeth, gums or lips when the tail flexible shaft rotates.

The fifth invention discloses that the flexible tube disclosed in the fourth invention has shape maintain property, whereby the tail flexible shaft can be bent to arbitrary angle and direction and maintained in a specific shape. The sixth invention discloses that the flexible tube disclosed in the fourth invention has shape recovery property, whereby the core shaft is maintained in a linear shape and the friction resistance of the core shaft is reduced to minimum.

The seventh invention comprises a torque display portion including a tightening torque sensor disposed in the handle body, and a shaft comprising a signal lead constituting the rope-shaped shaft or a part of the rope-shaped shaft to transfer signals of the tightening torque sensor, wherein the torque display portion has a circular shape concentric with the rope-shaped shaft and the rotational shaft of the handle body, or the torque display portion has a display device disposed in a housing concentrically with the rope-shaped shaft and the rotational shaft of the handle body. The tightening torque indication means is light, sound, or digital display on a small cross section of one side of the housing opposite to the side connected to the shaft.

The eighth invention discloses that the screw driver in the first invention further comprises a core shaft having a free end connected to a driving shaft of a power device; a flexible shaft having a tube on one end connected to a case of a driving device on which the power device is fixed and the other end connected to a handle cover capable of sliding in an axial direction of the handle body and rotatebly holding the handle body with respect to the rotational shaft; a lock mechanism engaging the handle body and the handle cover when the handle cover sliding toward a screw to be screwed; an open coil spring releasing the engagement of the handle body and the handle cover and preventing movement, wherein the rotation of the screw is operated by the power from the power device, and the handle cover slides toward the screw to be operated and is engaged with the handle body, whereby the screw is tightened or released by fingers.

### Effect of the Invention

The screw driver with tail disclosed in the first to eighth inventions is operated in an oral cavity. When the screw driver falls accidentally, the screw driver is avoided to be swallowed by pulling the tail up. When the tip blade corresponding to the heads of various screws is held by fingers and vertically pushed and rotated, in the moral teeth portion which is hard to keep vertical distance, the wire element or the rope-shaped tail shaft made of metal or resin can deform easily by its softness, flexibility and recovery property if the shaft interferes with teeth and gums. At the same time, the rope-shaped tail shaft has slightly curved shape and is kept outside the oral cavity. When the handle body is rotated to tighten or loosen screws, the rope-shaped tail shaft does not obstruct the operation caused by interference with the teeth, gums or lips. In case the screw driver falls, the tail shaft outside the oral cavity is pulled to avoid the screw driver entering weasand.

In the second invention, since a rotation gauge is disposed on the other end of the rope-shaped tail shaft outside the oral cavity, even the handle body is hidden in certain operation conditions, the rotation direction or rotation amount can be indicated by the rotation gauge.

In the third invention, the handle body is joined to the tail shaft by a ball join mechanism. When the tail shaft interferes with teeth or gums, the flexible tail shaft deforms and the join angle of the handle body and the tail shaft can be varied up to 90° within the angle range of the ball join mechanism. As the tail shaft can rotates freely, when the tail shaft is inserted into the handle body, even such a position behind the handle body where may have limited space and exceed the critical limit of the flexibility, softness and recovery property of the tail shaft, the tail shaft can still be kept in specific positions outside the oral cavity and functioned to avoid the falling of the screw driver.

In addition, when the ball joint mechanism serves as a rotation limit mechanism, tail shaft can rotates in the range set by the ball joint mechanism and change the join angle with the handle body to solve the limit space problem behind the handle body. At the same time, the handle body and the tail shaft rotates integrally. Similar to the second invention, as long as the rotation gauge is disposed on the tail shaft, the rotation amount and rotation direction of the screw driver can be aware. Since the rotation limit mechanism can transfer rotation torque from different directions, the rotation gauge can serve as a handle and the handle body is rotated by a rigid shaft, and a larger torque generated by lever effect can be used to tighten or loosen the screw. Of course, a torque wrench engaged with the rotation gauge can also be used.

In the ball join mechanism of the first, second or third invention, on which a rotation constrain element is disposed, when the handle body is rotated, tail shaft interfere the teeth, gums or lips and obstructs the rotation of screw driver due to insert position and angle, or the lips may be hurt by the rub of the tail shaft. As disclosed in the fourth invention, the tail shaft acts as a core shaft passing through a flexible tube to constitute a flexible shaft which prevent the tail shaft from rubbing the tissue near the tail shaft. The tube reduces the rotation resistance of the shaft and maintains the stable rotation of the shaft.

According to the fifth invention, a tube has shape maintain property. The flexible shaft is maintained in specific direction and angle outside the oral cavity in advance. When the screw driver is operated, the flexible shaft is in a position without obstructing the insertion of finger and the rotation of the handle body. At the same time, the flexible shaft can also be maintained in a direction without being hidden.

In addition, when a thin wire of metal or resin or a rope-shaped shaft formed by the wire is used, the shaft has no sufficient toughness for recovering shape. According to the sixth invention, however, the tube having shape recover property recovers shape by sufficient flexibility and softness and maintains a slightly curved shape along with the screw driver. At the same time, since the tail shaft is kept outside the oral cavity and has the least friction resistance for rotation, the handle body is easily rotated when the screw driver is operated.

The shaft or a part of the shaft constituting the screw driver with tail of the first invention is formed by a signal line. In the torque sensor driver displaying the signal of the tightening torque sensor disposed in the handle body on the other end of the shaft, when the screw driver is rotated, the display device is rotated along with the shaft. According to the seventh invention, the display device has a spherical shape or the tail shaft and the rotational shaft has concentric circular cross section, whereby the rotation resistance caused by the interference of the display device is reduced when the screw driver is operated. The entire display device or a part of the display device is disposed in a housing, whereby the rotation resistance can be further reduced. The shaft or a part of the shaft constituted by the signal line can serve as a core shaft passing through the flexible tube in the fourth invention, whereby the shaft is prevented from rubbing teeth, gums or lips to further reduce rotation resistance. The tightening torque indication means is light, sound, such as LED or digital display displaying words or symbols on a small cross section of one side of the housing opposite to the side connected to the shaft. The tightening torque can be indicated by the digital display at any rotation angle of the display device. In such a condition, as the flexible shaft is formed by the tube with shape maintain property, when the display device is disposed in any direction outside the oral cavity, the rotation resistance can vanish and the display device is easily seen.

In the eighth invention, the free end of a shaft passing through the flexible shaft serves as a core shaft is connected to a rotational shaft of a power device, and the tube on the free end is connected to a case of a driving device on which the power device is fixed. The other end is connected to a handle cover capable of sliding in the axial direction of the handle body and rotatebly holding the handle body with respect to the rotational shaft. In a narrow space such as the oral cavity, it is not necessary to hold and rotate the screw driver by fingers at the same time, which takes much labor.

In addition, an open coil spring disposed in the handle cover is used to release the engagement of the handle body and the handle cover. When the handle cover slides toward the screw, the screw can be tightened or loosened by finger with the engagement of the handle body and the handle cover, whereby the required torque from the power device is minimal. In such a condition, the rotation of the handle body and the handle cover can be 90°, which is a very small rotation. In this way, the handle cover is not needed to return and can have an excellent operation effect.

### BRIEF DESCRIPTION OF DRAWINGS

The invention can be more fully understood by reading the subsequent detailed description and examples with references made to the accompanying drawings, wherein:

FIG. 1 is a schematic view of a screw driver with a tail of the invention;

FIG. 2 depicts a screw driver B having a shaft co-axial with the rotational shaft of the handle body and swinging in a predetermined angle range, and a screw driver A having a rotation constrain mechanism co-axially rotating with the rotational shaft of the handle body and swinging in a predetermined angle range;

FIG. 3 depicts a screw driver having a flexible shaft with a flexible tube through which a shaft passes;

FIG. 4 depicts a screw driver of the invention rotating screws by a power device;

FIG. 5 is a schematic view of a lock mechanism of the handle of the screw driver of FIG. 4;

FIG. 6 depicts a screw driver having a flexible shaft connected to the handle body via a universal joint mechanism; and

FIG. 7 depicts a screw driver having a torque display device disposed in a housing and co-axially with the rotational shaft of the handle body and digitally displaying on a small cross section on a side opposite to the side connected to the shaft.

### SYMBOLS

1˜shaft, 2˜handle body, 3˜tip blade, 4˜tube, 5˜stopper, 6˜flexible shaft, 7˜handle cover, 8˜ball stud, 9˜torque wrench engage portion, 10˜latex glove, 11˜power device, 12˜magnet, 13˜universal joint, 14˜open coil spring, 15˜lock gear, 16˜handle cover lock mechanism, 17˜rotation gauge, 18˜C ring, 19˜C ring stopper, 20˜spherical slide bearing, 21˜display device, 22˜case, 23˜digital display

### DETAILED DESCRIPTION OF INVENTION

The embodiments of the invention are described a follows.

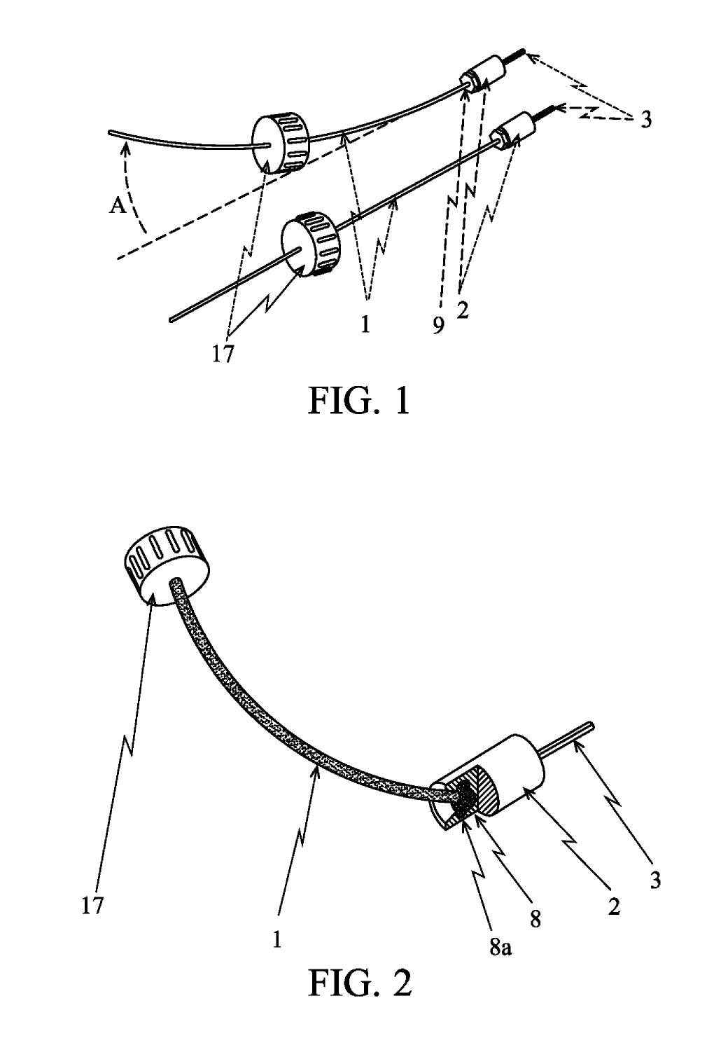

FIGS. 1 to 6 depict an embodiment of a screw driver of the invention. The same elements in FIG. 1 to 6 are referred by the same numbers. The tip of a screw driver of the invention is the same as typical screw drivers.

Referring to FIG. 1, a screw driver with tail of the invention comprises a tip blade 3 as a typical tip blade, a handle body 2 coaxially connected to the tip blade 3 and rotated by fingers, and a shaft 1 coaxially connected to the handle body 2 on one side opposite to the side where the blade 3 connected to the handle body 2. The shaft 1 has a metal or resin wire or a rope-shape. When the shaft 1 interferes with teeth, gums or lips, it is easy to recover a shape A by its flexibility and softness. When the stress caused by the interference is removed, the shaft 1 recovers its original shape, which is linear or slightly curved, due to its shape recovery property, whereby the shaft 1 has a proper length left outside the oral cavity. In case the screw driver falls into the oral cavity, the shaft 1 is pulled to prevent the screw driver falling into the weasand or throat. In addition, since the shaft 1 is made by resin or metal, it is easy for sterilization or disinfection.

Referring to FIG. 2B, the shaft 1 is connected the handle body 2 by a ball joint mechanism. A ball stud 8 joining the shaft 1 to the center of the ball is disposed on a rotational shaft of the handle body 2. The shaft 1 can do swinging, inclined moving, and rotation with respect to the handle body 2 by the ball joint mechanism which is pushed from the C direction of the slide bearing 20 having a C ring 18 set on a C ring stopper 19. A rotation constrain means constituted of a rotation constrain pin 8a is disposed on a slide bearing and a ball of the ball joint mechanism as shown in FIG. 2A. In such a structure, the shaft 1 can do swinging, inclined moving and rotation in a predetermined angle range set the ball joint mechanism, whereby the shaft 1 can rotate simultaneously with the handle body 2.

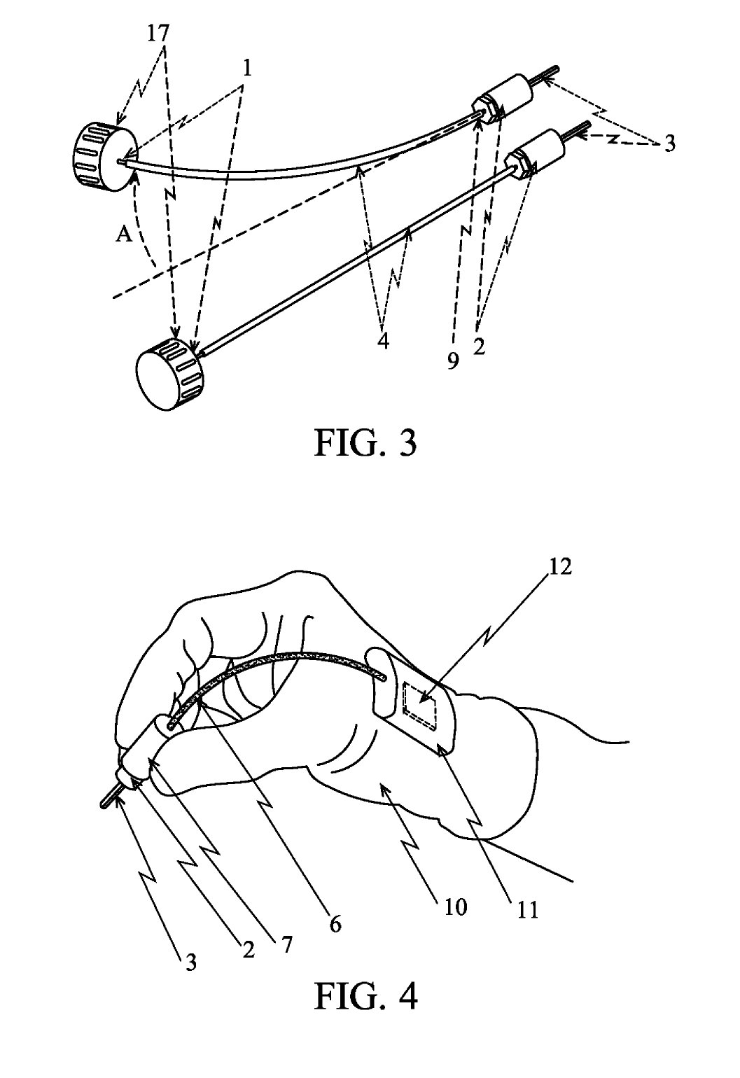

The straight tendency of the shaft 1 is inverse proportional to deformation amount. A flexible shaft structure shown in FIG. 3 has a flexible tube 4 rotatably covering the shaft 1, whereby the shaft 1 cannot hurt soft tissue in the oral cavity caused by the tendency to be straight. The teeth, gums or lips are protected by the flexible tube 4 from being rubbed by the rotating shaft 1 when the shaft 1 rotates along with the handle body 2. If the flexible tube 4 has shape maintain property, then the direction and angle of the flexible shaft can be maintained to a specific condition. If the flexible tube 4 has shape recover property, then the flexible shaft structure can be maintained to be substantially linear, whereby the rotation resistance of the shaft 1 (core shaft) can be reduced to a minimum. If a rotation gauge 17 is disposed on the other end of the shaft 1, when the handle body 2 is rotated by the finger or a torque wrench engaging a torque wrench engage portion 9 to tighten or loosen screws, the rotation gauge 17 outside the oral cavity rotates coaxially, whereby the rotation amount or rotational direction of the tip blade 3 can be recognized by eyes.

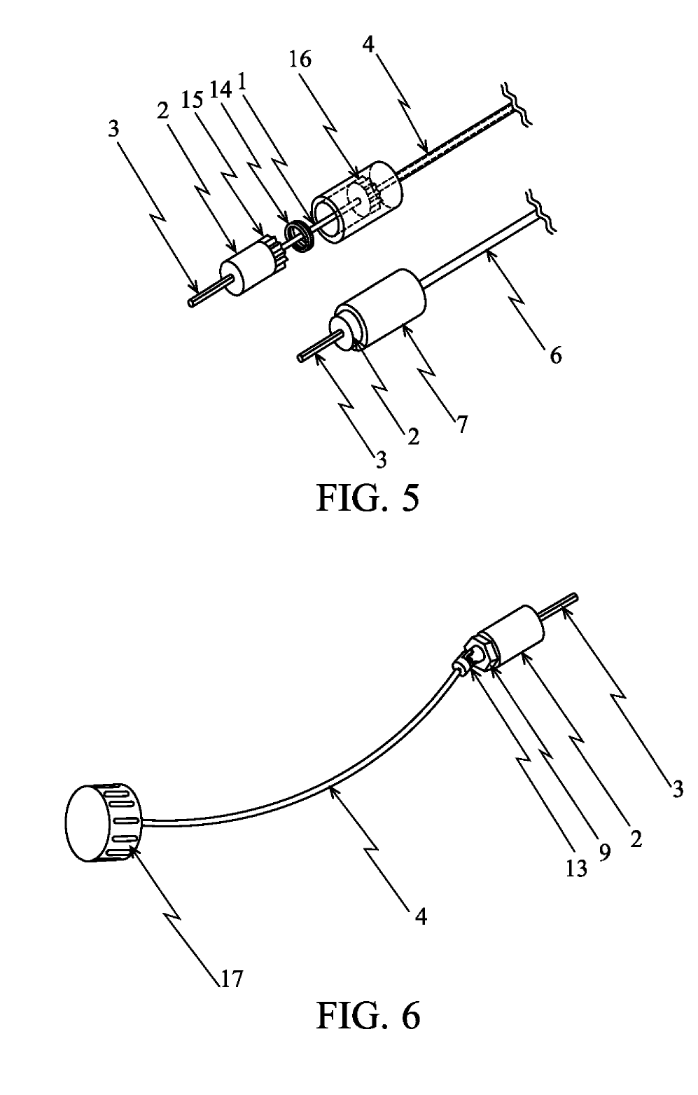

FIG. 4 shows the operation of tightening or loosening screws is performed by a power device. A free end of the shaft 1 serves as a core shaft 6 which is connected to a rotational shaft of the power device 11. One end of the tube is fixed to a housing 11 of the power device. The other end of the tube is connected to a handle cover 7 sliding axially on the handle body 2 and capable of rotating about the shaft 1. In such a structure, the screw driver is rotated by the power device, such a motor, rather than the handle body. Referring to FIG. 5, an open coil spring 14 disposed in the handle cover 7 releases the engagement of the handle body 2 and the handle cover 17 caused by the lock mechanism 15, 16. When the handle cover 7 slides toward the screw to be tightened or loosened, the lock mechanism 15, 16 joins the handle body 2 and the handle cover 7, whereby the screw can be tightened or loosened only by fingers. FIG. 6 shows a structure having a universal joint for joining the shaft 1 and the handle body 2. The universal joint can transfer moment from different direction. The rotation gauge 17 serves as a handle, and the handle body 2 is rotated via the non-deformable shaft 1, whereby a larger force generated by a lever effect is used to tighten or loosen the screws.

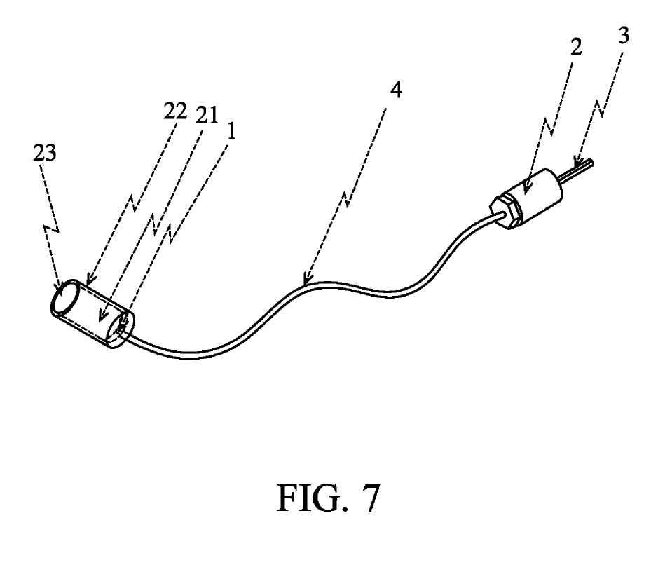

FIG. 7 shows a screw driver of the invention with a torque sensor separated from a display device. When the screw driver rotates, a torque display portion 21 is rotated along with the shaft 1 comprising the signal line. The display portion 21 is rotatably disposed in the case 22 and entirely or partially covered by a case 22, whereby the rotation resistance is further reduced. The shaft 1 as a core shaft rotatably passes through the flexible tube 4 connected to the case 22, whereby the shaft 1 is avoided contacting the teeth, gums or lips directly to further reduce the rotation resistance. The flexible tube 4 has shape maintain property, whereby the display portion is positioned for convenient observation and without obstructing the screw tightening or loosening operation. Since the flexible tube 4 is set in a directing convenient fro observing the digital display 23, the tightening torque of the screw driver can be indicated by the digital display for any rotation amount of the screw driver. In addition to the liquid crystal display, the digital display can also be LEDs disposed on the display portion 21 or a speaker disposed on the display portion or the combination of any described type. The display portion 21 can detachably disposed on the junction of the case 22 and the shaft 1 or the junction of the handle body 2 and the shaft 1, whereby electronic elements are not damaged during sterilization or disinfection.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

### UTILIZATION IN INDUSTRY

The screw driver with tail of the invention can prevent falling accident occurred in a limited space, such as oral cavity, in surgery operation. The rotation amount, rotation angle or rotation torque of the screw driver can be indicated on a position other than the screw driver itself. The screw driver of the invention is applicable for all operations for tightening or loosening screws in a closed portion.

What is claimed is:

1. A screw driver with a tail, comprising
a shaft having a tip blade corresponding to screw heads with a plurality of engaging shapes, disposed on one side of a rotational shaft of a handle body held by finger tips and rotating; and
a wire element, made of metal or resin, disposed on the other side of the rotational shaft of the handle body opposite to the side connected to the tip blade, or a rope-shaped shaft.

2. The screw driver with tail as claimed in claim 1, wherein a rotation gauge is disposed on the other side of the rope-shaped shaft.

3. The screw driver with tail as claimed in claim 1 or 2, wherein a rotation constrain mechanism is disposed on a ball or a slide bearing in such a manner that the rope-shape shaft is capable of swinging, inclined moving and rotating or capable of only swinging or inclined moving with respect to the handle body, and the rope-shape shaft rotates simultaneously with the handle body by a ball join mechanism, which has the ball having a center joined to the rope-shaped shaft or the wire element, and the ball is engaged with the slide bearing, which slides on the rotational shaft of the handle body and has a contact surface which is a spherical surface.

4. The screw driver with tail as claimed in claim 1 or 2 further comprising a tail flexible shaft structure comprising a flexible tube rotatably disposed in such a manner that the rope-shaped shaft passes through the flexible tube to be a core shaft.

5. The screw driver with tail as claimed in claim 4, wherein the flexible tube has shape maintaining properties.

6. The screw driver with tail as claimed in claim 4, wherein the flexible tube has shape recovering properties.

7. The screw driver with tail as claimed in claim 1 or 4, further comprising a torque display portion comprising a tightening torque sensor disposed in the handle body, and a shaft comprising a signal lead constituted by the rope-shaped shaft or a part of the rope-shaped to transfer signals of the tightening torque sensor, wherein the torque display portion has a circular shape concentric with the rope-shaped shaft and the rotational shaft of the handle body, or the torque display portion has a display device disposed in a housing concentrically with the rope-shaped shaft and the rotational shaft of the handle body, and the tightening torque is indicated by light, sound, or digital display on a small cross section of one side of the housing opposite to the side of torque display portion connected to the shaft.

8. The screw driver with tail as claimed in claim 4, further comprising:
a core shaft, having an open end connected to a driving shaft of a power device;
a flexible shaft having one end and a tube on the end connected to a driving device case to which the power device is fixed, and the other end connected to a handle cover capable of sliding in the axial direction of the handle body and rotatably holding the handle body with respect to the rotational shaft;
a lock mechanism engaging the handle body and the handle cover when the handle cover slides toward a screw to be screwed; and
an open coil spring releasing engagement of the handle body and the handle cover,
wherein the rotation of the screw is operated by power from the power device, and the handle cover slides toward the screw and is engaged with the handle body, so that the screw is tightened or untightened by fingers.
